(19) United States
(12) Patent Application Publication
(10) Pub. No.: US 2002/0083221 A1
(43) Pub. Date: Jun. 27, 2002

(54) Universal disk array controller

(75) Inventors: Vincent Tsai, Hsinchu (TW); Su-Syan Huang, Hsinchu (TW); Lian-Rong Wang, Hsinchu (TW)

Correspondence Address: Haverstock & Owens LLP, Suite 420, 260 Sheridan Avenue, Palo Alto, CA, 94306, US

(73) Assignee: Accusys, Inc.

(21) Appl. No.: 10/046,794

(22) Filed: Oct. 26, 2001

(30) Foreign Application Priority Data
Nov. 1, 2000 (TW) 89123023

(51) Int. Cl. G06F 13/42

(52) U.S. Cl. 710/1; 710/110

(57) ABSTRACT

A disk array controller is configured to communicate with the PCI-based host computer with a known standard PCI protocol. The standard PCI protocol typically defines a message provided for the disk array controller to negotiate with the PCI-based host computer. The message is represented by the PCI class code. By programming the PCI class code register in the PCI configuration space register (offset address 09H-0BH) with appropriate hex codes, the disk array controller will be identified as a stand PCI bus master IDE controller, and can be driven by the PCI bus master IDE controller driver utility, which is built in most of the PC-based operating system.

### FIELD OF THE INVENTION

The present invention is in relation to a redundant arrays of inexpensive disks (RAID) controller. In particular, the present invention is in relation to an universal RAID controller which is allowable to be driven by a driver utility provided by any PC-based operating system, without the requirements to be driven by a vendor-specific private driver utility.

### BACKGROUND OF THE INVENTION

In the contemporary computer system, the bus architecture is constructed for the purpose of allowing the central processing unit (or CPU) to communicate with other peripheral devices to perform data transactions thereof. Thus far, the most common bus architecture employed in the computer system for permitting the CPU and the system memory to carry out data transactions with the peripheral devices is built of a peripheral component interconnect (or PCI) bus. In addition to the PCI bus, a disk interface bus is required to provide a communication path among the CPU and the system memory and the disk drives. Currently, the most popular disk interface bus used in a PCI-based host computer is an integrated drive electronics (or IDE) bus because of its less-expensive price. A small number of the PCI-based host computer uses a small computer systems interface (or SCSI) bus as the control interface among the disks and the host processor and the system memory.

A disk controller, and more particularly a redundant arrays of inexpensive disks (RAID) controller which handles the I/O operation among the host computer and at least one array of disks, is either directly mounted on the motherboard of the host computer or interposed in the PCI slot for establishing a communication channel among disk drives and host computer. With respect to the current disk array controller, the PCI-IDE/PCI-SCSI RAID controller is the most popular disk array controller for use in a PCI-based host computer to control the operations of a plurality of arrays of disks. Typically, the PCI-IDE/PCI-SCSI RAID controller is interposed in the PCI slot and communicates with disks by IDE/SCSI bus.

Unfortunately, hitherto there has not been instituted a standard specification for the driver utility of the RAID controller. Therefore, a private driver utility must be developed by the RAID controller's vendor to cooperate with their individual RAID controller product, such that the RAID controller can be detected and function properly under the operating system running on the host computer. In this manner, the RAID controller driver utility will be different from operating system to operating system and from vendor to vendor, resulting in an inconsistency among the RAID controller driver utilities under different RAID controller manufacturers and different operating systems.

The applicant is inclined to provide a RAID controller which is permitted to be driven by the driver utility provided by any PC-based operating system, while eliminating the demand of being driven by the vendor-specific private driver utility.

### SUMMARY OF THE INVENTION

It is, therefore, a primary object of the present invention to provide a disk array controller which allows to be configured for being driven by the driver utility provided by any PC-based operating system.

It is a further object of the present invention to provide a disk array controller which can be universally employed in a variety of PCI-based host computers, in which an operating system is running on the PCI-based host computer and is provided with a common driver utility for actuating the operation of the disk array controller.

To achieve the object of the present invention, a disk array controller is provided for a host computer to couple with at least one array of disk drives. The disk array controller according to a preferred embodiment of the present invention includes at least a core logic unit for handling the I/O data transactions among the host computer and the disk drives, a disk control unit electrically connected to the core logic unit for communicating with the disk drives through a disk interface bus such as an IDE bus, and a bus controller for communicating with the host computer through a host PCI bus by a known standard PCI protocol. In one conspicuous aspect of the present invention, the known standard PCI protocol is designated to as a PCI class code. By programming the PCI class code register in the PCI configuration space register with appropriate hex codes, the disk array controller will be identified by the host computer as a standard PCI bus master IDE controller, and thus can be driven by a PCI bus master IDE controller driver utility which is prevalently built in most of PC-based operating system.

Now the foregoing and other features and advantages of the present invention will be more clearly understood through the following descriptions with reference to the accompanying drawings, in which:

### BRIEF DESCRIPTION OF THE DRAWINGS

FIG. 1 is a block diagram depicting a disk array controller of the present invention; and

FIG. 2 is a table listing the message format of the PCI class code.

### DETAILED DESCRIPTION OF THE PREFERRED EMBODIMENT

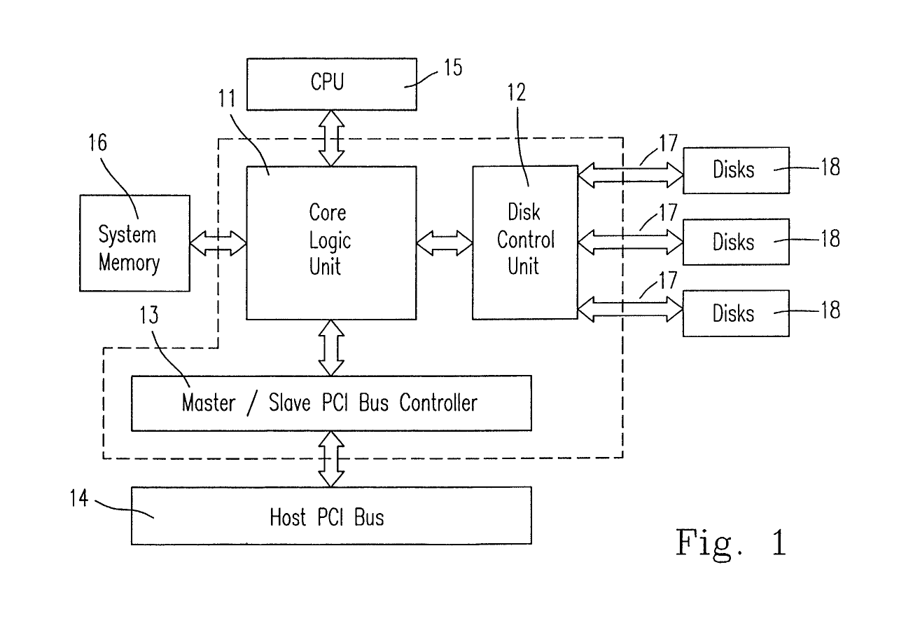

Turning now to FIG. 1, a disk array controller of the present invention is provided to couple a host computer to an array of disk drives 18. For the sake of simplification, only a portion of the hardware components of the entire host computer, such as host PCI bus 14, CPU (central processing unit) 15, and system memory 16, are shown. The disk array controller of the present invention is comprised of a core logic 11 unit for handling the I/O data transactions among the CPU 15, the system memory 16, and the disk drives 18. The disk array controller of the present invention also includes a disk control unit 12 electrically connected to the core logic unit 11 for communicating with the disk drives 18 through a first system bus 17 (which can be constructed from an IDE bus or a SCSI bus, but it is constructed from an IDE bus in this illustrative embodiment). A bus controller 13 (which can preferably be formed of a master/slave PCI bus controller) is provided to couple with the core logic unit 11 and communicates with the host computer through a second system bus 14 (which can be fulfilled with a host PCI bus) by a specific protocol, for example, a standard PCI protocol.

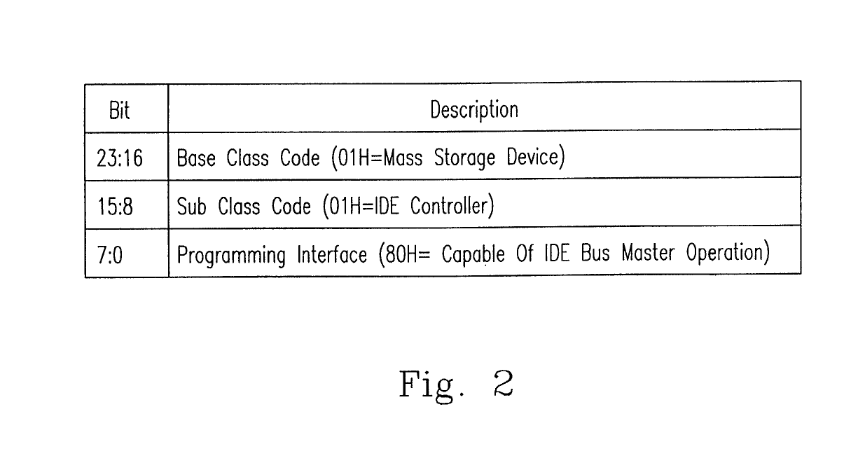

The aforesaid standard PCI protocol defines a message to let the disk array controller to negotiate with the host computer. According to the present invention, the message as defined by the standard PCI protocol is typically referred to as PCI class code, and the format of the PCI class code is shown with reference to the table of FIG. 2. It can be seen from FIG. 2 that the PCI class code is a 24-bit message, and can be segmented into three fields. Bit 0 to bit 7 is the programming interface field, bit 8 to bit 15 is sub class code field, and bit 16 to bit 23 is the base class code field. To attain the foregoing objective of the present invention that the disk array controller can be driven by the driver utility provided by any PC-based operating system, one may program the PCI class code register in PCI configuration space register (offset address 09H-0BH) by filling the programming interface field with the value of 80H, which represents “capable of IDE bus master operation”, filling the sub class code field with the value of 01H, which represents “IDE controller”, and filling the base class code field with the value of 01H, which represents “mass storage device”. As a result, one can sequentially program the PCI class code register with the value of 800101H from least significant bit to the most significant bit, such that the disk array controller will be identified by the host computer as a standard PCI bus master IDE controller and can be driven by the PCI bus master IDE controller driver utility, which is built in most of the PC-based operating system such as Microsoft Windows 98/95, Linux, IBM OS/2 Warp and so on. Therefore, the disk array controller will no longer need a private driver utility, but can be driven by a common PCI bus master IDE controller driver utility, which is built in any PC-based operating system.

It is apparent from the above discussions that the disk array controller of the present invention is secure from the constraints of being driven by a private driver utility, but can be driven by an ordinary built-in disk driver utility provided by any PC-based operating system. For this reason, when installing and configuring the disk array controller, it is unnecessary to rely on the vendor-specific driver utility to identify and setup the disk array controller, but it is possible to be driven in compliance with the disk controller driver utility provided by the operating system. In this way, the reliance on the private driver utility for the disk array controller can be thoroughly eliminated, and the disk controller can be compatible with all kinds of PC-based operating system.

Those of skill in the art will recognize that these and other modifications can be made within the spirit and scope of the present invention as further defined in the appended claims.

What we claim is:

1. A disk array controller for coupling a host computer to an array of disk drives, comprising:
a core logic circuit for handling an I/O operation among said host computer and said array of disk drives;
a disk control unit connected to and configured to control an operation of at least one disk drive of said array through a first bus of said host computer; and
a bus controller which communicates with said host computer through a second bus of said host computer by means of a message defined by a specific protocol of said second bus, in order that said disk array controller is configured to be driven through said second bus by a specific disk driver utility which is provided by an operating system running on said host computer.

2. The disk array controller according to claim 1 wherein said first bus is an integrated drive electronics (IDE) bus.

3. The disk array controller according to claim 1 wherein said first bus is a small computer systems interface (SCSI) bus.

4. The disk array controller according to claim 1 wherein said second bus is a peripheral component interconnect (PCI) bus.

5. The disk array controller according to claim 4 wherein said peripheral component interconnect bus is provided with a configuration space register for storing said message therein.

6. The disk array controller according to claim 1 wherein said bus controller is a master bus controller.

7. The disk array controller according to claim 1 wherein said bus controller is a slave bus controller.

8. The disk array controller according to claim 1 wherein said message defined by said specific protocol of said second bus comprises a PCI class code.

9. The disk array controller according to claim 8 wherein said message comprises a 24-bit data packet.

10. The disk array controller according to claim 1 wherein said specific disk driver utility is a PCI bus master IDE controller driver utility.
